(19) United States
(12) Patent Application Publication
(10) Pub. No.: US 2006/0002686 A1
(43) Pub. Date: Jan. 5, 2006

(54) Reproducing method, apparatus, and computer-readable recording medium

(75) Inventor: Yuji Arima, Ogouri-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/167,928

(22) Filed: Jun. 28, 2005

(30) Foreign Application Priority Data
Jun. 29, 2004 (JP) P2004-191148

(51) Int. Cl. H04N 5/76; H04N 5/91

(52) U.S. Cl. 386/96; 386/98

(57) ABSTRACT

An apparatus capable of reproducing voice information that is received from a communication terminal through a network and transmitting image information to the network, includes a voice reception buffer that stores the voice information, a level determining unit that determines the voice information stored in the voice reception buffer as a no-data or a no-sound when the stored voice information is lower than a first value, and a buffer control unit that discards the voice information determined as the no-data or the no-sound and compacts the remaining voice information.

### BACKGROUND OF THE INVENTION

The present invention relates to a reproducing method, an apparatus and a computer-readable recording medium for naturally reproducing the image information and the voice information, which are inputted through a network having a heavy traffic load.

In recent years, there has spread the network system, in which an image is taken by a network camera and is transmitted to a computer system through the network such as the internet. However, this network system can acquire the image information by controlling the computer system but not the surrounding voice information. Thus, there has been developed the network camera (as will be called the “voice mapping type network camera”), which is enabled to perform not only the image communication but also the voice communication by mounting a speaker and a microphone.

FIG. 8 is an explanatory diagram of a network system for the voice communication of the related art. In this network system, in connection with the transmission of an image, an image taken by a camera 1 of a voice mapping type network camera 1 is compressed by an image processor 12, and this compressed image data is processed in a protocol by a communication control unit 13. This processed data is sent to a network 3 and to a computer system 2. This computer system 2 decompresses the image data received, and displays it on a screen.

On the other hand, the image to be taken is processed into an image of a desired angle and zoom by controlling the pan, tilt and zoom [symbol] camera by the (not-shown) camera control unit. The browser (i.e., the pe [symbol] program of screen displaying information) of the computer system 2 displays the portal screen showing the image and the control bar in the monitor, when it receives the portal screen displaying information through the network 3. When the user controls the pan, tilt and zoom by the control bar, the JAVA (of a registered trade mark) applet or the like transmits the IP packet confining data of a control quantity from the communication control unit 13 to the voice mapping type network camera 1. In this voice mapping type network camera 1, a control unit 9 extracts the data from that IP packet and transmits the control quantity to the camera control unit so that the (not-shown) pan motor, the (not-shown) tilt motor and the (not-shown) linear actuator are driven to change the taking direction and the zoom of the camera 10.

Next, in connection with the voice communication, the voice inputted from a microphone 17 is subjected to an AD conversion and a compression by a voice transmission processor 15 so that the voice transmission data is sent through the communication control unit 13 and the network 3 to the computer system 2. This computer system 2 processes the voice transmission data received, and outputs a voice from a speaker 28. Likewise, the voice inputted from a microphone 27 of the computer system 2 is processed by the computer system 2 and is transmitted as the voice reception data so that it is sent through the network 3 to the voice mapping type network camera 1. In this voice mapping type network camera 1, the voice reception data received is transferred through the communication control unit 13 to a voice reception processor 14, in which the data is decompressed and DA-converted and is outputted to a speaker 18.

In case this voice mapping type network camera 1 transmits the image and the voice to the computer system 2, a time stamp is generally made on the individual data of the image and the voice, that is, the transmission is made by adding synchronous information of time information (as referred to JP-A-9-27871, for example). Both the voice and image data are given the synchronizing information by the time control, and the data having the synchronizing information is reproduced on the reception side so that both the voice and image data are synchronously outputted. At this time, the voice has a determined data length, but the image data is not determined on its output time. In case the network has a heavy traffic load, therefore, this terminal device finds it difficult to transmit all the image data and the voice data, and thins the data. As a result, the image and the voice are partially cut to interrupt the voice. The interrupted voice is hard to listen thereby to deteriorate the information transmission seriously.

There also exists the time stamp method, in which a synchronization is made by adding a frame number to the image data and the voice data. However, the time stamp and the frame number have to be added individually to the image data and the voice data. In case the configuration is so complicated that the network has a heavy traffic load, it is difficult for the terminal device to transmit all the image data and the voice data. As a result, the voice is interrupted, and the configuration is complicated to raise the cost.

There has also been proposed a multimedia multiplex transmission device, which does not cut the voice but creates a multiplex signal efficiently in case the voice signal is a voiceless sound (JP-A-2001-16263). This device is provided with a voice signal buffer unit and a voiceless sound detecting unit, and the voice signal buffer unit stores the voiced encoded signal temporarily. When there is detected the case in which the voice signal caught by an external microphone is voiceless, the write of the data is enabled, in case the input signal from the voiceless sound detecting unit is at a low level, but disabled in case the same is at a high level. Thus, the time area assigned to the voice signal of the multiplex signal is not uselessly assigned to the vide-encoded signals. In case a voice is made voiceless in the processing, a time period longer than necessary is taken from a low level to a high level. In case a voiceless sound is changed into a voiced sound, the level is instantly changed from high to low. These changes do not break the voices at the head and end of a word.

The voice mapping type network camera of JP-A-9-27871 transmits image and voice data, a synchronization is made by adding synchronous information such as time information to each image and voice data or by adding a frame number to each image and voice data. In the case of a heavy traffic load of the network, however, those synchronizing methods have found it difficult to transmit all the image data and the voice data. If a delay occurs, the data have to be thinned so that the image and voice reproduced are partially cut and interrupted. Moreover, these techniques are just to thin the data on the data transmission side but are not solutions for the problem on the reception side, which receives the influences of the traffic fluctuations. If the traffic load is heavy, the packet of the voice data is delayed not to decrease but to increase the voice delay in the voice buffer of the computer system.

On the other hand, the multimedia multiplex transmission device of JP-A-2001-16263 includes a voice signal buffer unit and a voice/voiceless detection unit. In case the voice signal detected by the outside microphone is voiceless, the device does not cut the voice but inhibits the data write so that the device can create the multiplex signal efficiently. In case the voice signal of the external microphone is a voiceless sound, the area assigned to the voiceless sound signal of the multiplex signal to be sent from the multimedia multiplex transmission device is assigned to the video encoding signal. Therefore, this technique does not solve either the problem of the computer device on the reception side. The problem thus far described is left unsolved if the traffic load is heavy.

### SUMMARY OF THE INVENTION

In view of the above problems of the related art, therefore, the invention has an object to provide an apparatus, a method for reproducing image information and voice information, and a computer-readable recording medium, which can utilize a buffer effectively even with much no-sound data or with a delayed packet.

In order to achieve the above object, according to the present invention, there is provided a terminal for storing voice information, if received through a network, temporarily in a voice reception buffer, for decoding the voice information outputted from the voice reception buffer and for outputting a voice after DA-converted. This terminal includes a buffer control unit for controlling the input/output of the voice information to and from the voice reception buffer, and a reception buffer level determining unit for deciding it as a no-data or a no-sound that the voice information in the voice reception buffer is at a predetermined peak value or less continuously for a predetermined time period, and it as a sound that the same exceeds the peak value. The terminal is mainly characterized in that the voice information determined as the no-data or no-sound by the buffer control unit is discarded, and in that the remaining voice information is compacted and outputted to a voice processing unit.

According to the apparatus, the method for reproducing image information and voice information, and the computer-readable recording medium of the invention, the delay is improved by discarding the voiceless portion even if the voice delay increases.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a configuration diagram of a network camera according to a first embodiment of the invention, and FIG. 1B is an internal block configuration diagram of the inside of a control unit of the network camera according to the first embodiment of the invention;

FIG. 2 is a block configuration diagram of a computer system according to the first embodiment of the invention;

FIG. 3A is an explanatory diagram of a portal screen display of the computer system according to the first embodiment of the invention, and FIG. 3B is an explanatory diagram of a setting screen for a no-sound erasure of FIG. 3A;

FIGS. 4A to 4E are explanatory diagrams of the data processing of a voice reception buffer of the computer system according to the first embodiment of the invention;

FIG. 5 is an explanatory diagram of a data discard of a voice reception buffer according to the first embodiment of the invention;

FIG. 6 is an explanatory diagram of threshold settings for deciding no-data and no-sound of the voice reception buffer according to the first embodiment of the invention;

FIG. 7 is a flow chart at the time when the no-data and no-sound data are discarded by the network camera and the computer system according to the first embodiment of the invention;

FIG. 8 is an explanatory diagram of a list of display of images for the voice communications of the related art;

FIG. 9 shows a hardware configuration diagram of a camera according to a second embodiment of the invention; and

FIG. 10 shows an appearance of the camera according to the first embodiment of the invention.

### DETAILED DESCRIPTION OF THE PREFERRED EMBODIMENTS

In order to solve the above-specified object, according to the invention, there is provided a method for reproducing and outputting image information and voice information by receiving the image information and the voice information from a camera through a network, comprising: storing said voice information; deciding it as a no-data or a no-sound that said voice information is lower than a predetermined threshold, and it as a voice that the same is higher than a predetermined threshold; and discarding the voice information decided as the no-data or the no-sound, and compacting the remaining voice information.

The voice information decided as the no-data or the no-sound in the voice reception buffer is discarded, and the remaining voice information is compacted and outputted as a voice. As a result, the voice reception buffer can be effectively utilized, and the voice is neither delayed from the image nor cut. Thus, the method of the invention is hardly influenced by the traffic fluctuations.

### DESCRIPTION OF THE PREFERRED EMBODIMENTS

### First Embodiment

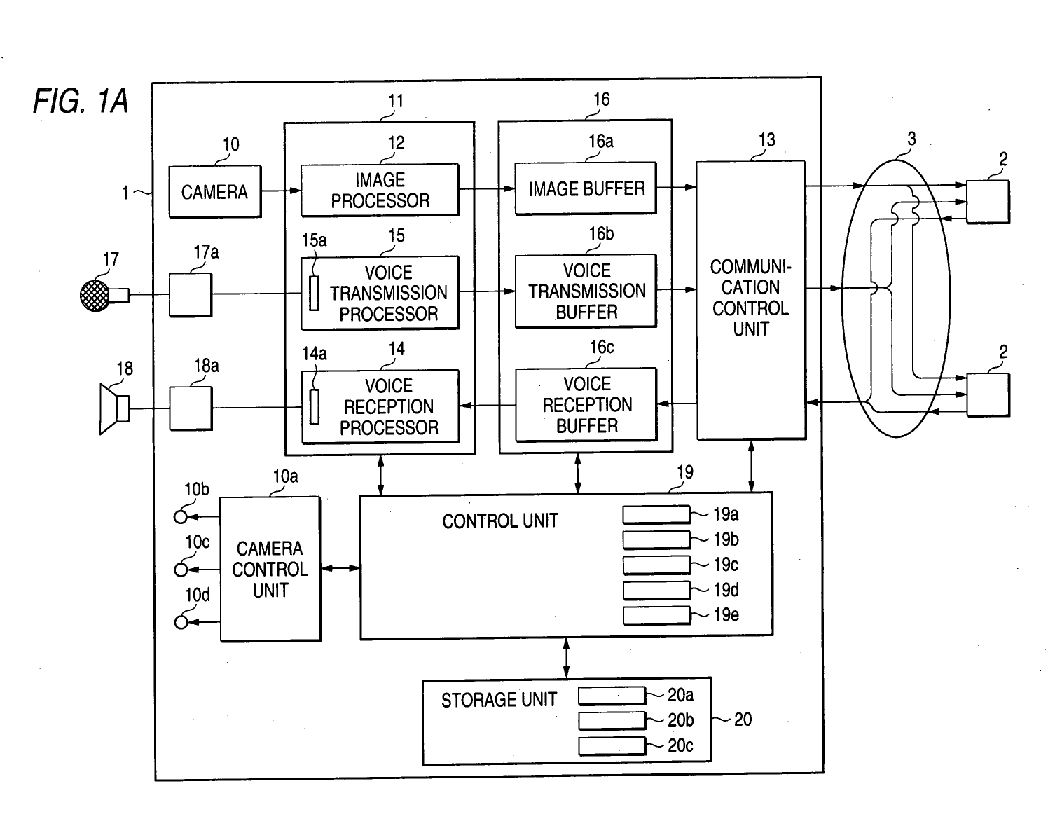

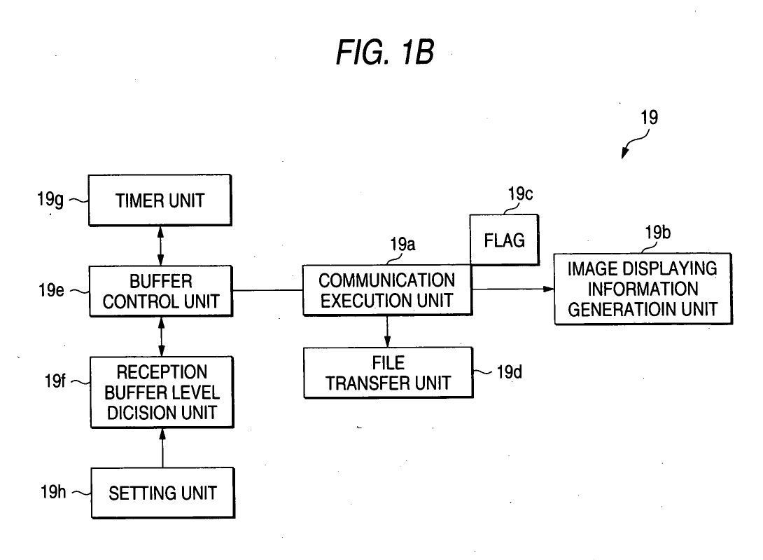

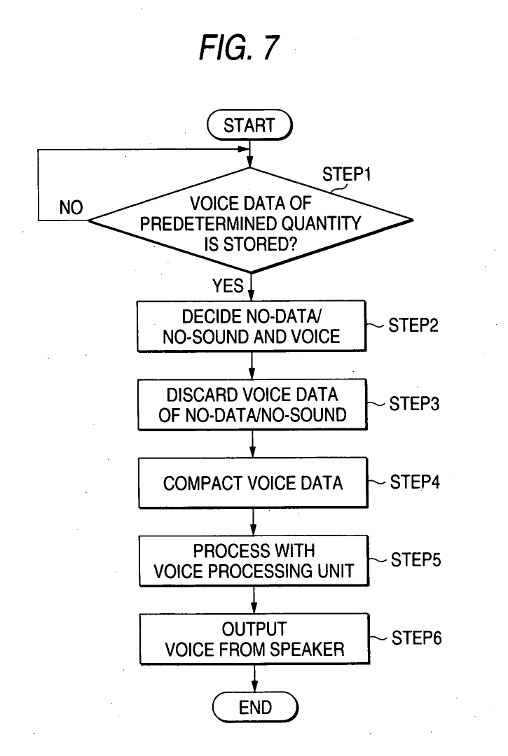

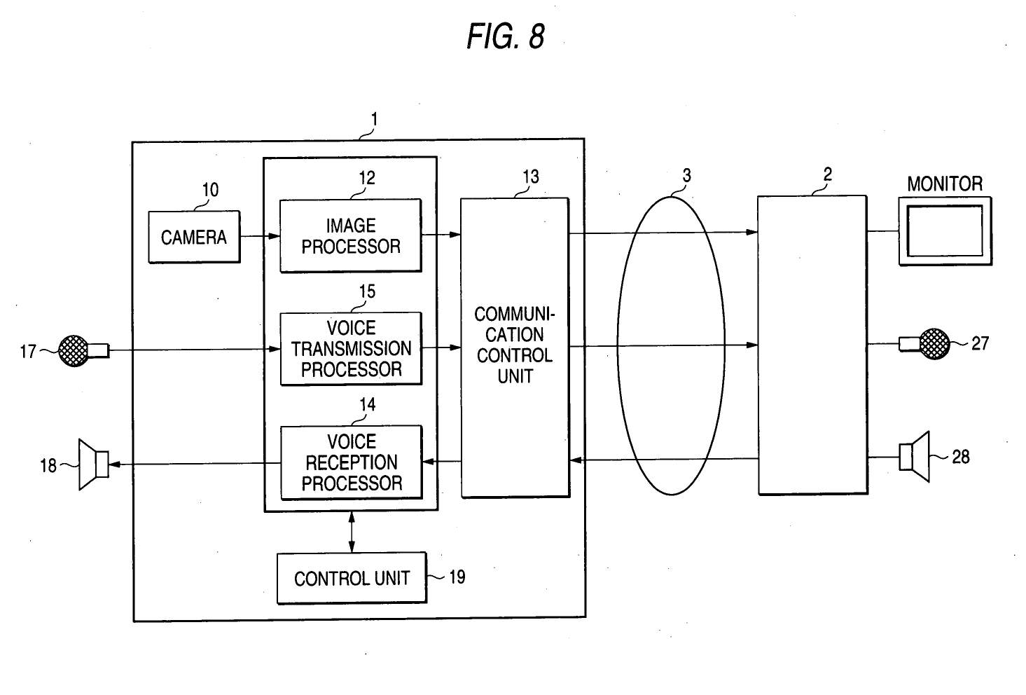

A network camera, a program and a network system according to the first embodiment of the invention will be described in the following. As to FIGS. 1A through 6, the same reference characters as those of a voice mapping type network camera 1 and a computer system 2 of FIGS. 7 and 8 are basically unchanged in the first embodiment.

In FIGS. 1A and 1B, numeral 1 designates a voice mapping type network camera (or a network camera of the invention) having such a voice communication device mounted thereon and capable of taking and sending image and having voice communications, numeral 2 designates a computer system (or a terminal of the invention) such as a personal computer capable of having the voice communications, and numeral 3 designates a network such as the internet or Ethernet (of a registered trade mark). Numeral 10 designates a camera of the voice mapping type network camera 1, and numeral 10a designates a camera control unit for controlling the pan, tilt and zoom of the camera 10. Numeral 10b designates a pan motor for controlling the panning action of the camera 10; numeral 10c a tilt motor for controlling the tilting action of the camera 10; and numeral 10d a linear actuator for a feeding action to control the zooming of the camera 10.. The computer system 2A controls the panning, tiling and zooming operations based on a control bar on the portal screen. The control bar is acquired from the voice mapping type network camera 1 and displayed on the computer system 2A. Then, the IP packet containing the data of the panning, tilting and zooming control variables is transmitted from the computer system 2 by the JAVA (of the registered trade mark) applets. The voice mapping type network camera 1 extracts the control data from that IP packet and transmits the control variables to the camera control unit 10a so that the pan motor 10b, the tilt motor 10c and the linear actuator 10d are individually driven to change the imaging direction and the zoom.

Numeral 11 designates a codec unit for compressing and decompressing the data to be transmitted and received. Numeral 12 designates an image processor for compressing the image signals taken by the camera 10. Numeral 13 designates a communication control unit for processing the image data compressed by the image processor 12 in the protocol and for transmitting the processed data. Here, this protocol processing indicates the processing such as the TCP/IP protocol or the IEEE 802.03 protocol of the Ethernet (of the registered trade mark).

Numeral 14 designates a voice reception processor for decoding the voice reception data (or the PCM data) received by the voice mapping type network camera 1. Numeral 14a designates a DA converter for converting the output or a digital signal of the voice reception processor 14 into an analog signal. Numeral 15 designates a voice transmission processor for encoding the voice inputted to the voice mapping type network camera 1. Numeral 15a designates an AD converter for converting the output or an analog signal from a voice input adjusting circuit 17a (as will be described hereinafter). Numeral 16 designates a buffer unit of the voice mapping type network camera 1. Numeral 16a designates an image buffer of the buffer unit 16 and for the image data such as JPEG or MPEG compressed by the image processor 12. Numeral 16b designates a voice transmission buffer of the buffer unit 16 and for the PCM data encoded by the voice transmission processor 15. Numeral 16c designates an FIFO (first In First Out) voice reception buffer of the buffer unit 16 and for buffering the PCM data transmitted from the computer system 2 via the network 3.

This voice reception buffer 16c buffers a large quantity of voice reception data transmitted, temporarily in accordance with the relationship between the ability and quantity of processing. In a case that the traffic load rises, the data to arrive is decreased due to the delay of packets so that the processing seems to have no problem. However, a problem is occurred that the time band in which the data cannot be fetched is continues so that a no-data area is mixed into the data of the voice reception buffer 16c. Specifically, the first-in data is continuously outputted, but the data of packet delay is not written in the memory elements configuring the voice reception buffer 16c, that is, the memory elements are not charged. When this state of no data is transferred to the voice reception processor 14, this voice reception processor 14 has to perform the meaningless processing. In the First embodiment, therefore, this area of no data and the intrinsic no-sound state of a low volume of sound are detected and discarded. The no-data and the no-sound will be called together the “no-data/no-sound”.

Next, in FIG. 1A, numeral 17 designates a microphone for inputting the voice around the voice mapping type network camera 1, numeral 18 designates a speaker for outputting a voice, and numeral 18a designates a voice output adjusting circuit. The (not-shown) echo cancellers may be interposed between the microphone 17 and the voice transmission processor 15, and between the speaker 18 and the voice reception processor 14 to prevent such a loop for creating an echo from being established that the voice outputted from the speaker 18 is inputted again to the microphone 17 and outputted from a speaker 28 on the side of the computer system 2 and is again inputted from a microphone 27.

In FIGS. 1A and 1B, numeral 19 designates a control unit of the voice mapping type network camera 1, numeral 19a designates a communication execution unit (or the communication unit of the invention) for performing a voice communication and an image transmission when the voice communication mode is selected from the computer system 2; and numeral 19b designates an image displaying information generation unit for creating the screen displaying information to be transmitted. from the voice mapping type network camera 1 to the computer system 2. Numeral 19c designates a flag for indicating the communication state of the plural computer systems 2 accessing to the voice mapping type network camera 1, such as the state in which the voice is being transmitted, in which the voice is being received, or in which the right to control the pan, tilt or zoom is being exercised, and numeral 19d designates a file transfer unit for downloading the program to control the computer system 2, i.e., the later-described terminal side communication processing unit 26, such as the program of the active x or the JAVA (of the registered trade mark) applets stored in a transmission file storage 20b.

Next, numeral 19e designates a buffer control unit for controlling the write action and the output action of the PCM data in and to the voice reception buffer unit 16c. Numeral 19f designates a reception buffer level decision unit for deciding whether or not the level of the data corresponds to the no-data/no-sound; and numeral 19g designates a timer unit for counting whether or not the state of no-data/no-sound continues for a predetermined time 10. period. In the first embodiment, in case the no-data/no-sound continues for the predetermined time period, the buffer control unit 19e discards (or erases the charge) the entire data of the time period and makes the control to eliminate the area of the no-data/no-sound by advancing the discarded area to the subsequent data. The reception buffer level decision unit 19f is set with a threshold for evaluating the voice and the no-data/no-sound. The reception buffer level decision unit 1 9f decides the no-data/no-sound, when the level is at the threshold or lower, and informs the buffer control unit 19e of the decision. In the first embodiment, the no-data/no-sound is decided when the detected level is at the threshold or lower for 365 ms, but a proper set value may be adopted for the time duration. In response to this notice, the buffer control unit 19e causes the timer unit 19g to count a predetermined time, so as to decide whether or not the no-data/no-sound continues. When the timer unit 19g counts out, it is decided that the no-data/no-sound has occurred. Moreover, numeral 19h designates a setting unit for setting the aforementioned threshold. Next in FIG. 1A, numeral 20 designates a storage unit stored with program or the like for controlling the system, numeral 20a designates a screen displaying information storage stored with the template of portal screen displaying information or other screen displaying information (e.g., web pages), and numeral 20b designates a transmission file storage stored with the program (as will be called the “terminal side communication processing unit”) to be transmitted to the computer system 2 and executed by the CPU of the computer system 2, such as the active x or the JAVA (of the registered trade mark). Numeral 20c designates an image storage for storing the image data compressed in the image processor 12. Here, the above screen displaying information described with the HTML or the like is stored in the screen displaying information storage 20a. When, however, the images of the individual voice mapping type network camera 1 are to be displayed in a list with the portal screen displaying information, each image data displayed is stored in the image storage 20c of the voice mapping type network camera 1.

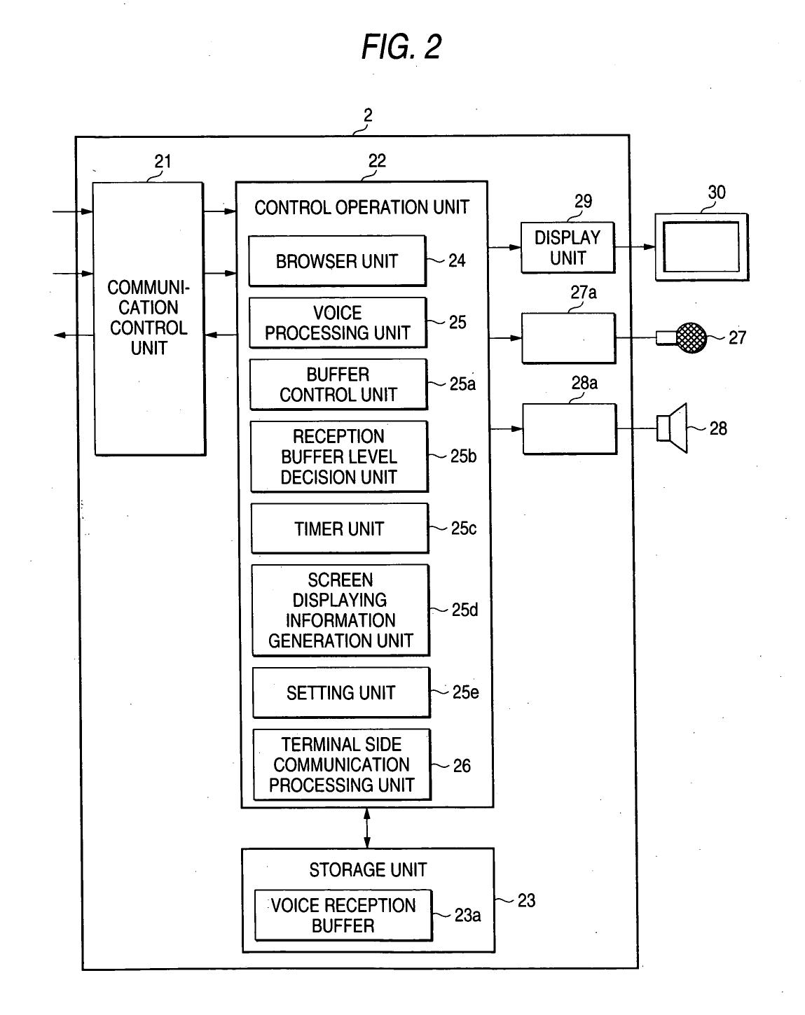

The configuration of the computer system 2 will be described with reference to FIG. 2. In FIG. 2, numeral 21 designates a communication control unit acting as an interface with the network 3, numeral 22 designates a control operation unit equipped with a CPU as a hardware and realized as a function realizing unit by reading the program from a storage unit 23 that is configured to store a program and data, and numeral 23a designates a voice reception buffer for storing voice data. Moreover, numeral 24 designates a browser unit for acquiring and perusing the image displaying information from the web site on the network 3, and numeral 25 designates a voice processing unit realized as a function realizing unit with the voice processing program such as the JAVA (of the registered trade mark) applet program or the plug-in.

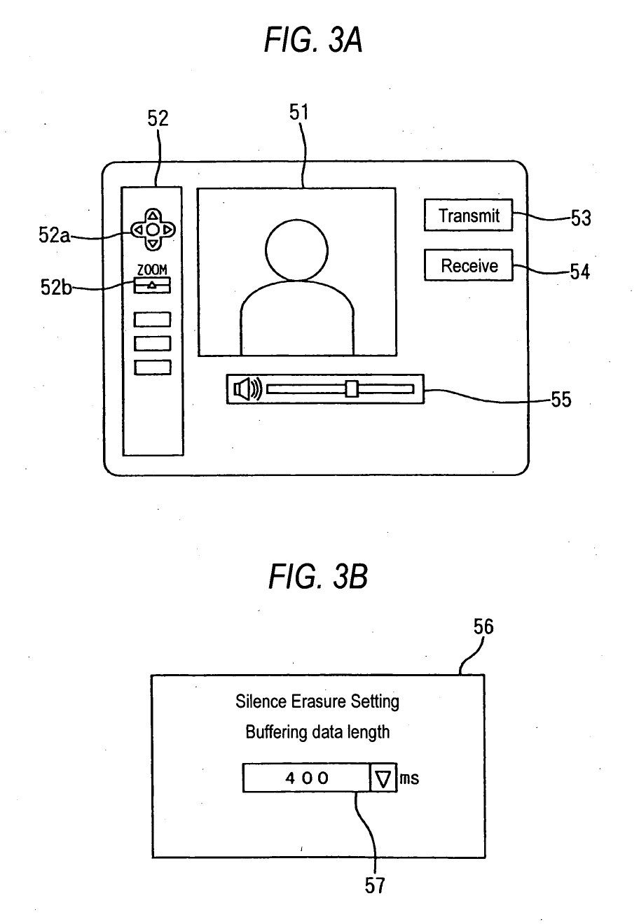

Moreover: numeral 25a designates buffer control unit for controlling the write action and the output action of the PCM data to the voice reception buffer 23a, numeral 25b designates a reception buffer level decision unit for decision whether or not the level is equivalent to the no-data/no-sound; and numeral 25c designates a timer unit for counting whether or not the state of no-data/no-sound continues for a predetermined time period. Moreover, numeral 25d designates a screen displaying information generation unit for creating a no-sound erasure setting screen 56 (as referred to FIG. 3B) to vary the threshold for deciding the no-data/no-sound at the voice reception buffer 23a, with the buffering data length. Moreover, numeral 25e designates a setting unit for setting the threshold when the buffering data length is inputted from the no-sound erasure setting unit 56.

On the other hand, the numeral 26 designates the terminal side communication processing unit which is realized by the program downloaded by the file transfer unit 193 of the voice mapping type network camera 1, such as the active x or the JAVA (of the registered trade mark). The numeral 27 designates the microphone, numeral 27a designates a voice input adjusting circuit, the numeral 28 designates the speaker, numeral 28a designates a voice output adjusting circuit, numeral 29 designates a display unit, and numeral 30 designates a motor.

With reference to FIGS. 3A and 3B, here will be described the portal screen displaying information and the no-sound erasure setting screen, which are transmitted to the computer system 2 by the voice mapping type network camera 1 of the first embodiment. In FIG. 3A, numeral 51 designates an image area of time-varying images or still images, and numeral 52 designates a control bar for controlling the pan, tilt and zoom of the camera 10 of the voice mapping type network camera 1. Numeral 52a designates a direction control button, and numeral 52b designates a zoom adjusting bar. Here, the control bar 52 is prepared with a button for calling a set screen to discard the later-described no-data/no-sound data. Numeral 53 designates a voice transmission button for transmitting the voice to the voice mapping type network camera 1 when depressed, and numeral 54 designates a voice reception button for receiving the voice made in the voice mapping type network camera 1. Numeral 55 designates a volume adjusting bar for adjusting the volume to be outputted from the speaker 18 of the voice mapping type network camera 1. The client of the voice mapping type network camera 1 receives and displays the portal screen displaying information on the monitor 30, and controls the direction control button 52a and the zoom adjusting bar 52b, while observing the images on the portal screen, to switch the angle or the like of the camera 10 thereby to acquire a new image. In the voice transmission mode, on the other hand, the client pushes the voice transmission button 53 to transmit the voice, and pushes the voice reception button 54 to receive the voice on the side of the voice mapping type network camera 1.

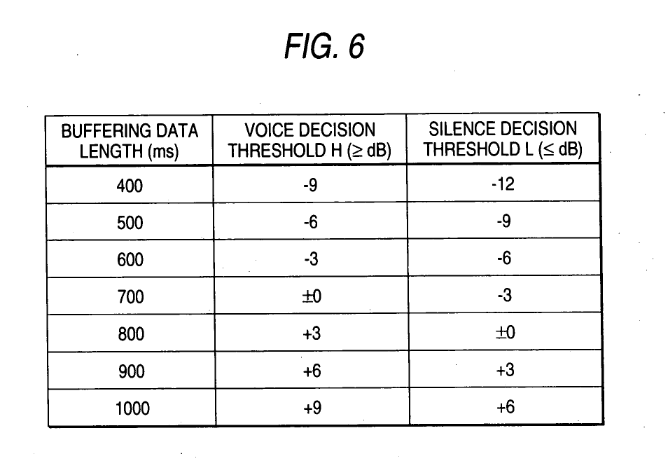

Subsequently in FIG. 3B, the numeral 56 designates the no-sound erasure setting screen for varying the threshold to decide the no-data/no-sound in the voice reception buffer 23a, as described above, with the data length, and numeral 57 designates a setting box for setting the buffering data length. For simplicity, this screen will be called the “no-sound erasure setting screen”. When the no-sound erasure setting button displayed in the control bar 52 of the portal screen is pushed, the no-sound erasure setting screen 56 created by the displaying information generation unit 25d is called and displayed in the monitor 30. Buffering data lengths such as 400 ms, 500 ms, 600 ms, 700 ms, 800 ms, 900 ms and 1,000 ms are inputted to the setting box 57, one of which can be selected, as shown in FIG. 6. Although detailed hereinafter, the threshold for deciding the no-data/no-sound may take one value. In FIG. 6, however, a pair of different thresholds are individually set for the case, in which the state is varied from the no-data/no-sound to the voice, and for the case, in which the state is varied from the voice to the no-data/no-sound. Specifically, the thresholds are set to the threshold H (dB) at the time when the state is varied from the no-data/no-sound to the voice, and to the threshold L (dB) at the time when the state is varied from the voice to the no-data/no-sound. When the buffering data length is inputted as 400 ms at the setting box 57, for example, the threshold H is set to −9 dB whereas the threshold L is set to −12 dB by the setting unit 25e.

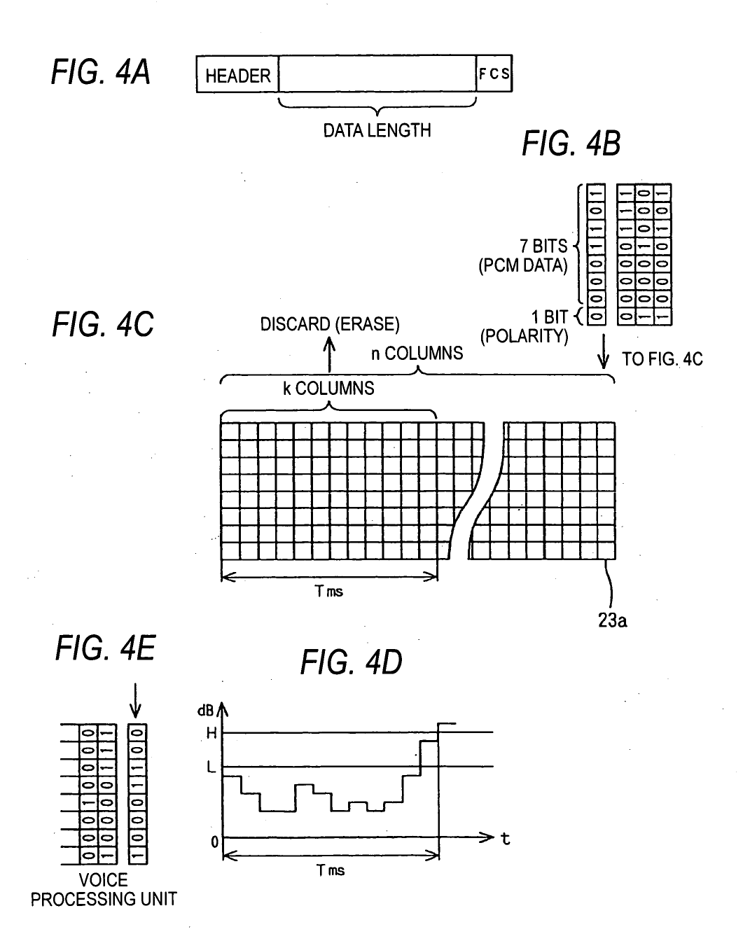

Subsequently, the actions to discard the no-data/no-sound at the voice reception buffer 23a of the computer system 2 will be described in detail with reference to FIGS. 4A to 4E, FIG. 5 and FIG. 6. FIG. 4A shows the IP packet containing the voice data transmitted from the voice mapping type network camera 1. The voice data of one frame is stored after the header. These voice data are fetched by the communication control unit 21, and the buffer control unit 25a transfers the PCM data of 8 bits at the unit of 8 bits to a predetermined column of the voice reception buffer 23a. In 8 bits of the PCM data, as shown in FIG. 4B, the leading 1 bit is assigned to discriminate the polarity (+, −), and the remaining 7 bits indicate the peak value. Since the compression coefficients are different according to the so-called “μ rule” or “A rule”, so that the PCM data take different values according to the compression methods.

The buffer control unit 25a shown in FIG. 4C has a buffer capacity of (8 x n) bits in the FIFO and includes memory element arrays of n columns at the unit of 8 bits. The buffer control unit 25a transfers and writes the PCM data at the leading end, and outputs the PCM data at a predetermined rate of 8 bits at the terminal end so as to output the voice at a uniform rate. After outputting, the charges (indicating the PCM data) of the remaining columns are transferred sequentially for each column to the terminal end.

Here, the graph of FIG. 4D illustrates the peak values of the PCM signals. The data of k columns corresponding to the width of T ms (e.g., 365 ms in the first embodiment) become lower than the threshold L on the terminal side and higher than the threshold H on the leading side. Here, the peak values are the absolute values excepting the polarity (i.e., 1 bit). The PCM data of (8×k) bits for T ms have low peak values and are decided to be in the no-sound state so that they are discarded. In the case of no data, peak values 0 of a k number are arranged. The output is made at the unit of 8 bits, as shown in FIG. 4E, and is inputted to the voice processing unit 25. In this voice processing unit 25, the input is converted into voice digital signals (or PAM signals), which are converted by the not-shown DA converter into analog signals and outputted as analog signals from the speaker 28.

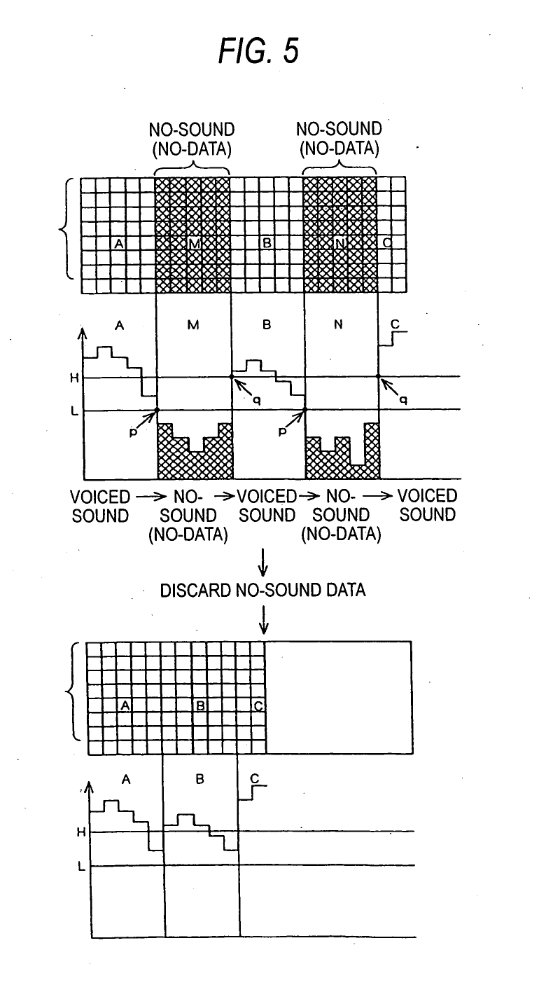

When data of a predetermined quantity is stored in the voice reception buffer 23a, the buffer control unit 25a discards the no-data/no-sound data and sequentially compacts and outputs the voice data. The actions of the voice reception buffer 23a at this time will be described with reference to FIG. 5. In FIG. 5, the voice areas decided by the reception buffer level decision unit 25b are A, B and C, and the areas of the no-data/no-sound are M and N. The PCM signal becomes gradually smaller in the area A and than the threshold L at a point p, passes through the area M and crosses the threshold H at a point q so that it becomes the PCM signal in the area B. This PCM signal takes the maximum in the area B, crosses again the threshold L at the point p, passes through the area N and crosses the threshold H at the point q. Here, if the area A is positive, the area B is negative with an exception. Thus, the point p takes a lower threshold, and the point q takes a higher threshold. This difference is made to prevent the final data of the voice from being excessively cut. Moreover, the point p to be evaluated as the no-data/no-sound is set to the low value for ensuring the reliability. When the voice is returned, the area surely has passed through the area for the evaluation of the no-data/no-sound. Thus, the decision is not mistaken even if the threshold is made slightly higher at the point q.

The areas M and N of the no-data/no-sound thus decided are discarded (or discharged) by the buffer control unit 25a, and the areas A, B and C are sequentially compacted. This state is shown in the two lower diagrams of FIG. 5. It is found that the buffer capacities are made sufficient. The areas A, B and C are continuous, and the output is made as if the no-data/no-sound are absent.

However, it cannot be said better that the decision of the no-data/no-sound is always made with the constant thresholds L and H. Specifically, the threshold H is lowered to increase the voice data for the voice, when the buffering data length of the voice reception buffer 23a is short. When the buffering data length is large, the threshold L and the threshold H are increased to reduce the voice data for the voice. These operations are preferred for causing no delay. With these decisions, moreover, the area of no data is always at the threshold L or lower. Even in case the threshold L and the threshold H are varied, it is possible to eliminate the influences due to the fluctuations in the traffic load of the network 3.

In FIG. 6, the buffering data lengths can be set to 400 ms, 500 ms, 600 ms, 700 ms, 800 ms, 900 ms and 1,000 ms, and the threshold L and the threshold H are set with a hysteresis of 3 dB. With this difference of 3 dB, it is possible that the last data of the voice is not excessively cut, and it does not occur that the voice and the no-data/no-sound are misjudged.

The threshold L and the threshold H are increased in proportion to the buffering data length as this data length increases. This increase is reasoned in the following. In case the buffer capacity is large, it is frequently proportion to the size of the quantity of the PCM data received. If the range for deciding the no-data/no-sound is widened by raising the threshold L and the threshold H (or the thresh levels), it is possible to decrease the operations to be processed by the voice processing unit 25. If the threshold H is set to −9 dB and the threshold L is set to −12 dB for the buffering data length of 400 ms, they can be preferably increased by 3 dB at every 100 ms from 400 ms to 1,000 ms so that the threshold H may take +9 dB whereas the threshold L may take +6 dB at 1,000 ms. The threshold L and the threshold H are varied with a difference of 3 dB for every 100 ms of the buffering data length.

Here, the description thus far made is directed mainly on the discard setting process and the erasing action of the no-sound data at the voice reception buffer 23a of the computer system 2. Especially, the description is made on the computer system 2 for forming the voice reception buffer 23a by transmitting the program such as the JAVA (of the registered trade mark) applets from the voice mapping type network camera 1 and for configuring the terminal communication processor 26 to communicate, but the invention should not be limited thereto. Moreover, all these descriptions are similar to those of the discard setting process and the erasing actions of the no-sound data in the voice reception buffer 1 6c of the voice mapping type network camera 1, and the detailed description is omitted because of the overlap. Here, the voice processing unit 25 of the computer system 2 performs the function of the voice reception processor 14 at the voice receiving time and the function of the voice transmission processor 15 at the voice transmitting time. In the computer system 2, moreover, the client receives the portal screen and displays the no-sound erasure setting screen 56 for inputting the settings. In the case of the voice mapping type network camera 1, however, the manager sets from the maintenance terminal.

Subsequently, here is described the flow for discarding the no-data/no-sound data between the network camera and the computer system according to the first embodiment of the invention. FIG. 7 is a flow chart at the time when the no-data and no-sound data are discarded by the network camera and the computer system of the first embodiment. In FIG. 7, the routine is awaited (at step 1) till the voice data (or the PCM data) of a predetermined quantity is stored in the voice reception buffer 23a. The reception buffer level decision unit 25b decides whether the voice data is the no-data/no-sound (at step 2) or valid-voice when the voice data is stored at a predetermined amount.

The reception buffer level decision unit 25b discards the voice data (at step 3) in the area of no-data/no-sound, and compacts the spaces of the voice areas sequentially (at step 4). The voice is inputted to the voice processing unit 25 and converted into the voice digital signals (i.e. the PAM signals) (at step 5) so that the analog signals are outputted (at step 6) from the speaker 28 through the DA converter.

Thus, the voice reception buffer 23a varies the buffering data length, and varies the thresh levels according to the quantity of the voice data stored. As a result, the quantity of processing of the voice processing unit 25 can be reduced according to the traffic state at the voice communication time. Even with much no-data and no-sound data or with a packet delay, the voice is neither delayed to make effective use of the buffer nor influenced by the traffic load.

Further, the voice data is determined as the no-data or the no-sound when an absolute value of an amplitude information of the sound data is equal to or lower than a predetermined value for a predetermined time, and the voice data is determined as the voiced sound when the absolute value of the amplitude information of the sound data is higher than the predetermined value for the predetermined time. Therefore, a processing can be conducted with the small quantity of processing.

Further, the voice data is determined as the no-data or the no-sound when an integrated value of square power of the sound data at a predetermined time is equal to or lower than a predetermined value, and the voice data is determined as the voiced sound when the integrated value of the square power of the sound data at the predetermined time is higher than the predetermined value for the predetermined time. Therefore, a precise determining can be performed.

Further, the voice data is determined as the no-data or the no-sound when an absolute value of an amplitude information of the sound data is equal to or lower than the first value for a predetermined time, and the voice data is determined as the voiced sound when the absolute value of the amplitude information of the sound data is higher than the second value for the predetermined time. Therefore, the determination of a precise magnitude of the voice data by an average process and the determination of changing from voiced sound to a no-sound can be determined with different threshold values respectively so that a precise determination with the small quantity of processing can be achieved.

Further, the voice data is determined as the no-data or the no-sound when an integrated value of square power of the voice data at a predetermined time is equal to or lower than the first value, and the sound data is determined as the voiced sound when the integrated value of the square power of the sound data at the predetermined time is higher than the second value. Therefore, the determination of a precise magnitude of the voice data by an average process and the determination of changing from voiced sound to a no-sound can be determined with different threshold values respectively so that a more precise determination can be achieved.

Further, since the second value is set higher than the first value with wide spread, the last data of the voiced sound is prevented from cutting too excess. Also, when the sound data is transit to a voiced sound, the transition of the sound data is pass through an area determined as non-data or no-sound. Therefore, if the second value is rater high, the determination does not become an error.

Further, when a predetermined quantity of the voice data is stored in the voice reception buffer, the determining process determines whether the sound data is the no-data or the no-sound or the voiced sound. The discarding process discards the voice data determined as the no-data or the no-sound. Therefore, an inner of the voice reception buffer is arranged when a predetermined quantity of the voice data is stored therein. Therefore, the arranged sound data can be normally transmitted.

### Second Embodiment

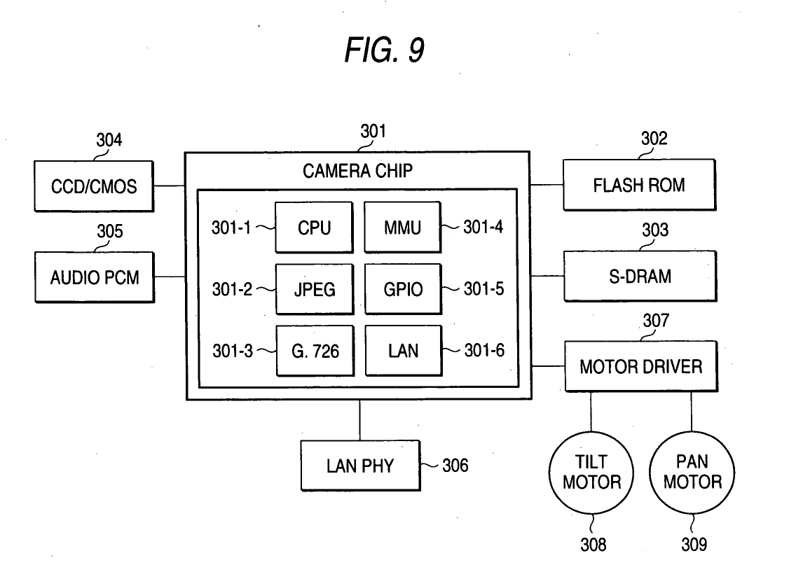

FIG. 9 shows a hardware configuration diagram of the camera of the invention.

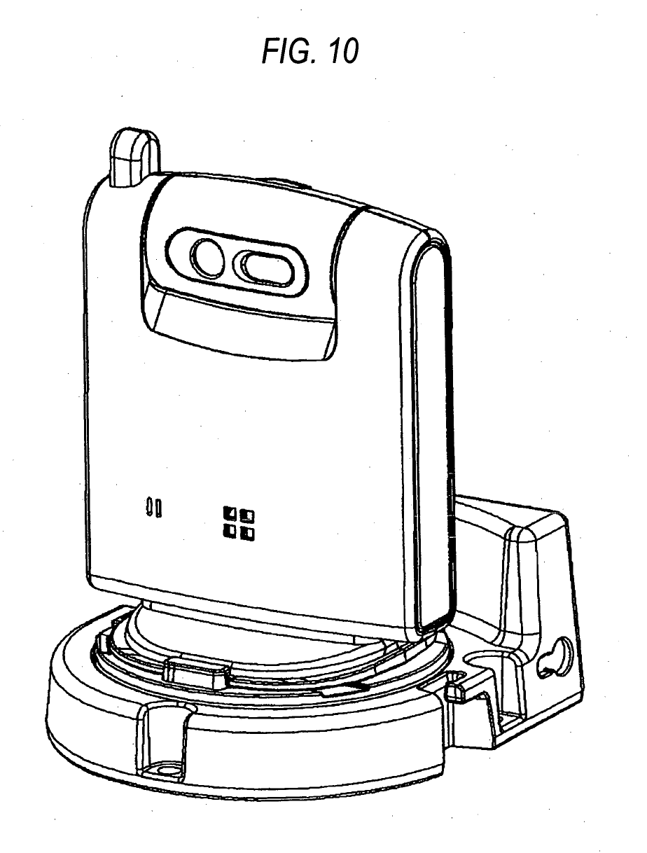

FIG. 10 shows an appearance of the camera of the invention.

Numeral 301 designates a camera chip containing the CPU and its peripheral circuits. Numeral 302 designates a flash ROM that stores the program and data for the actions of the camera chip 301. Numeral 303 designates a working S-DRAM for the cameral chip 301 to act. Numeral 304 designates a CCD and a CMOS chip for converting a taken image into electric signals. Numeral 305 designates an Audio PCM chip for inputting/outputting voice signals. Numeral 306 designates a LANPHY chip for an electric interface at the time of physical connections with a LAN interface. Numeral 307 designates a motor drive chip for moving the camera within a taking range, i.e., a Tilt motor 308 and a Pan motor 309. There are a microphone for voice inputting and a speaker for voice outputting, although not shown.

The camera chip 301 is configured by a CPU 301-1; a JPEG converter 301-2 for converting a taken image in electric signals, into an image of the JPEG format; a G.726 converter 301-3 for conversions into the voice data format for the network communication; an MMU (Memory Management Unit) 301-4; a GPIO (General Purpose Input/Output); and a LAN (Local Area Network) 301-6.

This hardware configuration diagram of FIG. 9 and the camera configuration diagram of FIG. 1 are mapped, as follows. The camera 10 corresponds to the CCD 304; the voice input adjusting circuit 17a and the voice output adjusting circuit 18a to the Audio PCM 305; the portion of the communication control unit 13 to be connected with the LAN to the LANPHY 306; the portion for the communication control unit 13 for the control actions to the LAN unit 301-6; the pan motor 10b to the Pan Motor 309; the tilt motor 308 to the Tilt Motor 308; the image processor 12 to the JPEG converter 301-2; the voice reception processor 14 and the voice transmission processor 15 to the G.726 converter 301-3; the camera control unit 10a and the control unit 19 for their controls to the CPU 301-1; and the storage unit 20 to the S-DRAM 303.

Moreover, it is possible to realize: the flash ROM 302 with MX29LV320; the S-DRAM 303 with MT48CM16; the Audio PCM chip 305 with AK2308; the LANPHY chip 306 with ICS1893; the CCD chip 304 with the combination of ICX098, MN5400 and HV7131; and the motor drive chip 307 with LB1937.

With these configurations, there can be realized the camera which is enabled to output image information to the network and to output an uninterrupted voice even for a dense communication traffic, by inputting the voice information from the communication terminal and by deciding the magnitude of the voice information received.

The invention can be applied to the network system for image transmissions and voice communications by using the voice mapping type network camera.

1. A method for reproducing image information and voice information, comprising:
receiving the image information and the voice information through a network;
storing the voice information;
determining the stored voice information as a no-data or a no-sound when the stored voice information is lower than a first value;
discarding the voice information determined as the no-data or the no-sound; and
compacting the remaining voice information.

2. The method as set forth in claim 1, further comprising a process of determining the stored voice information as a voiced sound when the stored voice information is equal to or higher than a second value.

3. The method as set forth in claim 1, wherein the stored voice information is determined as the no-data or the no-sound when an absolute value of an amplitude information of the voice information is equal to or lower than the first value for a predetermined time.

4. The method as set forth in claim 1, wherein the stored voice information is determined as the no-data or the no-sound when an integrated value of square power of the voice information at a predetermined time is equal to or lower than the first value.

5. The method as set forth in claim 2, wherein the stored voice information is determined as the no-data or the no-sound when an absolute value of an amplitude information of the voice information is equal to or lower than the first value for a predetermined time; and
wherein the stored voice information is determined as the voiced sound when the absolute value of the amplitude information of the voice information is higher than the second value for the predetermined time.

6. The method as set forth in claim 2, wherein the stored voice information is determined as the no-data or the no-sound when an integrated value of square power of the voice information at a predetermined time is equal to or lower than the first value; and
wherein the stored voice information is determined as the voiced sound when the integrated value of the square power of the voice information at the predetermined time is higher than the second value.

7. The method as set forth in claim 2, wherein the second value is higher than the first value.

8. The method as set forth in claim 2, wherein the second value is equal to the first value.

9. The method as set forth in claim 1, wherein the determining process is performed when the stored voice information exceeds a predetermined data quantity.

10. A computer-readable recording medium for causing a computer to execute the method as set forth in claim 1.

11. An apparatus capable of reproducing voice information that is received through a network and transmitting image information to the network, comprising:
a voice reception buffer that stores the voice information;
a level determining unit that determines the voice information stored in the voice reception buffer as a no-data or a no-sound when the stored voice information is lower than a first value; and
a buffer control unit that discards the voice information determined as the no-data or the no-sound and compacts the remaining voice information.

12. The apparatus as set forth in claim 11, wherein the level determining unit determines the voice information stored in the voice reception buffer as a voiced sound when the stored voice information is equal to or higher than a second value.

13. The apparatus as set forth in claim 11, wherein the level determining unit determines the voice information stored in the voice reception buffer as the no-data or the no-sound when an absolute value of an amplitude information of the voice information is equal to or lower than the first value for a predetermined time.

14. The apparatus as set forth in claim 11, wherein the level determining unit determines the voice information stored in the voice reception buffer as the no-data or the no-sound when an integrated value of square power of the voice information at a predetermined time is equal to or lower than the first value.

15. The apparatus as set forth in claim 12, wherein the level determining unit determines the voice information stored in the voice reception buffer as the no-data or the no-sound when an absolute value of an amplitude information of the voice information is equal to or lower than the first value for a predetermined time; and
wherein the level determining unit determines the voice information stored in the voice reception buffer as the voiced sound when the absolute value of the amplitude information of the voice information is higher than the second value for the predetermined time.

16. The apparatus as set forth in claim 12, wherein the level determining unit determines the voice information stored in the voice reception buffer as the no-data or the no-sound when an integrated value of square power of the voice information at a predetermined time is equal to or lower than the first value; and
wherein the level determining unit determines the voice information stored in the voice reception buffer as the voiced sound when the integrated value of the square power of the voice information at the predetermined time is higher than the second value.

17. The apparatus as set forth in claim 12, wherein the second value is higher than the first value.

18. The apparatus as set forth in claim 12, wherein the second value is equal to the first value.

19. The apparatus as set forth in claim 11, wherein the determining unit determines the voice information stored in the voice reception buffer as the no-data or the no-sound when the stored voice information is lower than the first value when the voice information stored in the voice reception buffer exceeds a predetermined data quantity.

20. A computer-readable recording medium for causing a computer to execute the method as set forth in claim 2.

21. A computer-readable recording medium for causing a computer to execute the method as set forth in claim 3.

22. A computer-readable recording medium for causing a computer to execute the method as set forth in claim 4.

23. A computer-readable recording medium for causing a computer to execute the method as set forth in claim 5.

24. A computer-readable recording medium for causing a computer to execute the method as set forth in claim 6.

25. A computer-readable recording medium for causing a computer to execute the method as set forth in claim 7.

26. A computer-readable recording medium for causing a computer to execute the method as set forth in claim 8.

27. A computer-readable recording medium for causing a computer to execute the method as set forth in claim 9.
